(19) United States
(12) Patent Application Publication
(10) Pub. No.: US 2011/0178936 A1
(43) Pub. Date: Jul. 21, 2011

(54) Electronic Justice System

(76) Inventor: Dewan Mohan, Maharashtra (IN)

(21) Appl. No.: 13/057,748

(22) PCT Filed: Jul. 20, 2009
(86) PCT No.: PCT/IN2009/000412

§ 371 Date: Feb. 4, 2011

(30) Foreign Application Priority Data
Jul. 18, 2008 (IN) 1526/MUM/2008

(51) Int. Cl. G06Q 50/00

(52) U.S. Cl. 705/311

(57) ABSTRACT

An electronic judicial system (100) adapted to carry out proceedings of a court, said electronic justice system comprising: an enactments' databasera precedents' database, a suit/case generating means, a pleading forming tool, a search engine, a court fee tool, an uploading tool, an analyzer means, an issue framing means, a behavioural analysis unit, an interfacing means, a case file means, an amendment tool, a judicial centre, and a judicial panel.

### FIELD OF THE INVENTION

This invention relates to the justice system.

What this invention envisages is an electronic justice system, particularly to dispense civil justice.

### BACKGROUND OF THE INVENTION

A court is a public forum used by a power base to adjudicate disputes and dispense civil, labour, administrative and criminal justice under its laws. In common law and civil law states, courts are the central means for dispute resolution and it is generally, understood that all persons have an ability to bring their claims before a Court. Similarly, those accused of a crime have the right to present their defence before a Court.

Lawyers are empowered to take up judicial matters, provide counseling, and represent clients in the court or in front of a magistrate. The magistrate has powers bestowed upon him by the district, state or country, depending upon his position, to administer proceedings and then dispense justice in accordance with provisions of the law and keeping in view the evidence, arguments, and counter-arguments provided to him.

The entire proceeding requires the physical presence of a magistrate or judge, a prosecutor counsel, a defence counsel, their respective clients at most times in a government building namely, a Court. A great deal of paperwork and time-coordination is involved to propel the proceedings in the rightful manner.

As a further corollary, the need to share information among justice agencies through automation is a global issue that has been around for more than 30 years. Over the years, the global justice community at the national, federal, district, state, provincial, county and local levels have created thousands of data pools. Unfortunately, none of these data pools are yet able to share data directly via electronic connections with other systems.

### PRIOR ART

U.S. Pat. No. 7,181,493 describes a platform independent model for exchanging information among numerous entities in a judicial system with diverse system components implemented in a hub and spoke arrangement. Each spoke includes a processing agent that communicates with a system component of an entity of the judicial system, translates from a common communication format to a communication format of the system component, and, manages the timing of the flow of information to/from the system component. The hub includes an information broker that communicates with each agent in the common communication format, determines what information is needed by which entity, and routes the needed information to/from respective agents for the entities that need the information. This is not suitably adapted and developed to replace the entire judicial procedure.

U.S. Pat. No. 6,330,557 describes a computerized system for automated dispute resolution through an Intranet website via the Internet or other communications linkage for communicating and processing a series of demands to satisfy a claim made by or on behalf of a claimant or other person involved in a dispute with at least one other person, such as a defendant, his or her insurer, or other sponsor, and a series of offers to settle the claim through at least one central processing unit including operation system software for controlling the central processing unit is disclosed. Preferably the system also allows for the collection, processing and dissemination of settlement data generated from the settlement through the operation of the system for use by sponsors and claimants in establishing the settlement value of future cases. However, the method is only for processing monetary disputes through the system.

The present invention aims to obviate the limitations of the prior art.

### OBJECTS OF THE INVENTION

One object of this invention is to provide a hassle-free method for dispensing justice.

Another object of this invention is to provide a method of dispensing justice which is less time consuming.

Yet another object of this invention is to provide a method of dispensing justice which is reliable.

Still another object of this invention is to reduce the amount of paperwork in the process of dispensing justice.

An additional object of this invention is to increase the use of electronic media to expedite the process of dispensing judgements.

Still, an additional object of his invention is to substantially automate the process of administering justice.

Another additional object of this invention is to automatically provide an electronic record of date and time of each and every part of the proceedings.

### SUMMARY OF THE INVENTION

According to the aspects of this invention, a means to dispense justice; to simulate a real court with an electronic version, and carry out the entire proceedings electronically is proposed.

For the purposes of this specification, the word, ‘Enactments’ is extended to include Acts, Rules, Orders, procedural facts, ordinances, directions, codified statutes, directions.

For the purposes of this specification, the word, ‘Precedents’ is extended to include case studies, commentaries, judgements to be used for citations and references.

For the purposes of this specification, the word, ‘Pleadings’ is extended to include plaints, applications, petitions, written statements, appeals, and rejoinders.

According to one aspect of this invention, there are provided various tools for assembling pleadings, applications, appeal memos and petitions attaching thereto the relevant enactments and precedents, serving the pleadings to the respective parties, collating evidence including documentary evidence, exhibits, examination of witnesses and their cross examination; attaching the collated evidence to the pleadings; means for analysis of the pleadings and the evidence and submission of the pleadings with attached enactments and precedents and the evidence to a judicial bench for adjudication.

The electronic judicial system in accordance with this invention is adapted to carry out proceedings of a court. The electronic justice system comprising:
an enactments' database adapted to store electronic versions of a plurality of enactments;
a precedents' database adapted to store a plurality of precedents;
a suit/case generating means adapted for use by a potential litigant to invoke said electronic judicial system and further adapted to permit logging into said system with all the facts relating to said suit/case;
a pleading forming tool comprising:
a) a template generating tool comprising a plurality of templates and adapted to generate electronic versions of pleadings;
b) pleading instructions receiving tool adapted to prompt statement of facts from an invoker of said system in, language of said invoker to generate said electronic versions of pleadings;
c) conversion tool adapted to convert said pleadings' instructions to a core pleading;
d) query generator means adapted to generate queries in cases wherein, said recorded facts depict a lacuna in formation of said electronic version of pleadings; and
e) translation means adapted to convert said prompted statement of facts and said generated electronic versions of pleadings in a uniform court language;
search engine adapted to scan said generated versions of pleadings and append to it, relevant provisions from said enactment database and said precedents' database to make a final formal pleading;
court fee tool adapted to service payment transactions relating to payment of court fees;
uploading tool adapted to upload documents and exhibits in scanned manner in order to substantiate claims of said plaintiff and said defendant;
analyzer means adapted to examine pleadings, remove objections, and formulate a final set of acceptable pleadings;
issue framing means adapted to analyze issues in the pleadings, frame electronic version of issues, record admission or denial or said exhibits and documents;
behavioural analysis unit adapted to monitor and analyse witness physical signs while recording evidence;
interfacing means adapted to interface said electronic version of plaint and said electronic version of written statement with a lawyer or a consortium of lawyers;
case file means adapted to receive and store pleadings generated by said pleading forming tool, reports from said behavioural analysis unit, amendments to said pleadings by said lawyer or said user, and rendered justice order;
amendment tool adapted to amend said electronic version of plaint and written statement; and
judicial centre adapted for handling administrative matters relating to litigation and recording of evidence comprising:
i) process service device adapted to serve summons to said defendant; and
ii) recording unit adapted to record evidence, arguments and communicate with said behavioural analysis unit and further adapted to store said recorded evidence and said recorded arguments in said case file; and
judicial panel adapted to receive and study said case file and issue a judgement.

Typically, said enactments' database is update-able.

Typically, said enactments', database includes a section for storing enactments relating to other countries and jurisdictions.

Typically, said precedents' database is update-able.

Typically, said suit/case generating means includes a case identification generating means adapted to identify a user with said relevant case.

Typically, said template generating tool includes templates selected from a plurality, of templates including plaints' templates, written statements' templates, rejoinders' templates, surrejoinders' templates, and sursurrejoinders' templates.

Typically, said pleading instruction receiving tool includes a language translation and language recognition tool.

Typically, said pleading instruction tool is adapted to receive instructions in a text format.

Typically, said pleading instruction tool is adapted to receive instructions in an audio format.

Typically, said conversion tool includes a set of pre-defined instructions to convert said pleadings' instructions to a core pleading.

Typically, said translation means includes a language conversion tool adapted to cater to a plurality of languages.

Typically, said analyser means is adapted to collate evidence in relation to entire case proceedings to generate an e-report and invoke said search engine to scan enactments and precedents and append to said e-report.

Typically, said system includes a security means adapted to provide security to said case file, and operable only, by said user and said lawyer.

Typically, said system includes a relaying means adapted for communication, transmittal and receipt of documents between, said plaintiff, said defendant, said lawyer of said plaintiff, said lawyer of said defendant, and said judicial centre.

### BRIEF DESCRIPTION OF THE ACCOMPANYING DRAWINGS

The invention will now be described in accordance with the accompanying drawings in which:

FIG. 1 illustrates an electronic system for dispensing justice, particularly in relation to a civil suit;

FIG. 2 illustrates the hierarchy and various tiers of the judicial system in accordance with the system of FIG. 1;

FIG. 3 illustrates a logical flow diagram of administering e-justice in accordance with this invention.

### DETAILED DESCRIPTION OF THE ACCOMPANYING DRAWINGS

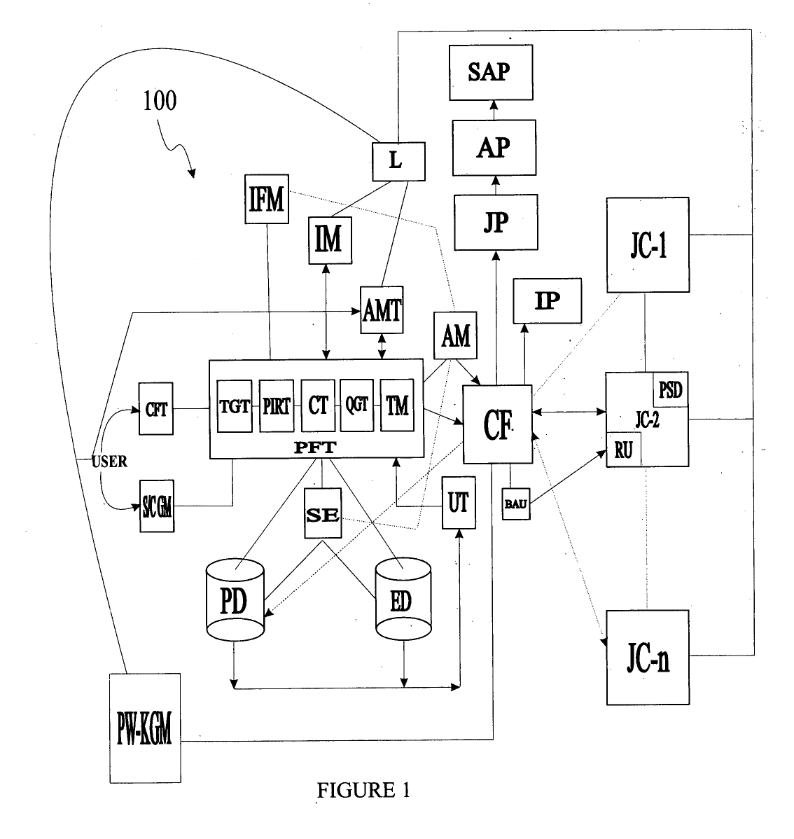

FIG. 1 illustrates an electronic system (100) for dispensing justice

Typically, the system (100) can be outlined briefly as follows:
a central bank of servers housing the precedents database (PD), the enactments database (ED), the search engine (SE), the suit/case generating means (S/C GM), the court fee tool (CFT), the pleading forming tool (PFT) having a plurality of nodes which can independently be accessed simultaneously by a multitude of USERS/Lawyers (L);
a judicial centre (JC) comprising the following:
a) objection removal section which correlates with an analyser means (AM) for annexing enactments and precedents from databases (ED, PD, SE) enforceable from the time period when the plaintiff (USER) invoked the system to the time the matter comes up for hearing;
b) process service section (PSD) for serving summons and issuing dates for further hearings;
c) issue framing section (IFM) adapted to frame e-issues in conjunction with functions of the analyser means (AM), said analyser means (AM) includes a human element as well as a machine element for carrying out the analysis;
d) trial section for recording arguments and evidence (RU);
e) behavioural analysis section (BAU), typically comprising equipment monitored by an array of people capable of analysing a witness' psychology, psychiatry, psychometric-ability the like attributes;
f) amendment section comprising the amendment tool (AMT) which works in conjunction by interfacing means (IM) and can be effected by a USER and/or a lawyer (L);
judicial panel comprising a plurality of hierarchically sorted tiers of judges viz.:
a) administrative panel (ADP) such as the Registrars that will supervise the pleadings portion of a case and check for removal of objections;
   b) trial panel (TP) that will supervise the evidence and arguments stage;
   c) judicial panel (JP) that will be involved in delivering the judgement from case to case;
   d) appellate panel (AP) that will hear appeals;
   e) supreme appellate panel (SAP) which is equivalent to supreme court; and
   f) interim panel (IP) that will provide interim orders and urgent orders.

The system (100) therefore has:

[1] an Enactments database (ED) which stores electronic versions of the provisions of the law, and all enactments including all Acts, Rules, Orders, procedural fiats, ordinances and directions. The enactments database (ED) is continuously updated as new laws are enacted and old ones repealed. As an extension, the enactments database (ED) will also include a section on corresponding laws in other jurisdictions and countries.

[2] A Precedents data base (PD) which includes case studies, commentaries, judgements and the like documents which can be used for citations and references throughout for supporting the proceedings of the court. The precedents database (PD) is also continuously updated.

[3] A suit/case generating means (S/C GM) by which a person (USER) who wishes to invoke the system (100) in accordance with this invention logs into the system (100) with all the facts for which the person (USER) wants to litigate.

[4] Password/Key-generation/Security Means (PW-KGM): there is provided a password/key-generation/security means (PW-KGM) wherein, the entire e-justice setup is password protected. Access can be provided only to registered lawyers (L) and litigants (USER) in relation to a particular case stored in a relevant case file (CF) while the case is under progress. After pronouncement of the judgement, the records can be made available to the general public. Such a system will make the e-justice system transparent and open to the public.

[5] Court fee tool (CFT): Once the e-plaint is uploaded with all documents, enactments, precedents and instructions, the court fee tool (CFT) of the system (100) calculates the fees payable and asks the invoker/plaintiff (USER) to pay the court fees for initiating the processing of the suit. These e-fees can be paid by means of an e-transaction, such as via a credit card. Once the Court fees and process fees are paid, an e-plaint with all electronic documents in favour of the plaintiff is generated and a suit commences. Electronic documents includes provisions of law, case studies, commentaries, judgements and the like documents referred to from said precedent means. A copy of the e-plaint is relayed to the corresponding defendant.

[6] Case File (CF): A blank Case File (CF) is created upon invoking the system (100). A case file (CF) is a central repository of the final saved activity at the end or the output of each section/stage, of the e-justice system (100). The case file (CF) is continually updated as the e-plaint is made, as the e-written statement is made, as the precedents searched by the search engine (SE) are added, as the enactments searched by the search engine (SE) are added, as the confidential report from the behavioural analysis unit (BAU) are added, as the amendments by lawyer (L) or USER are added, as the judgement and reports from the justice centre (JC) and the judicial panel (ADP, TP, JP, IP, AP, SAP) are delivered and added.

[7] A pleading forming tool (PFT) which has in it: (i) a template generating tool (TGT) for various templates required in the pleadings. These templates typically are formats which are editable for making plaints, applications, petitions, written statements. Once the templates are accessed, written into and sent to the concerned people/parties, there is provided a locking means to render the template un-editable/un-tamperable. (ii) a pleading instructions receiving tool (PIRT) which asks the invoker (USER) to digitally provide all the facts which has caused the person to invoke the system (100). The invoker (USER) can key in these facts in a language of the invoker's (USER) choice. (iii) A conversion tool (CT) adapted to convert said pleadings' instructions to a core pleading. (iv) A Query Generator Means (QGT) adapted to generate queries in case wherein, said recorded facts depict a lacuna in formation of said electronic version of pleadings. (v) A translation means (TM) which is adapted to convert the keyed in facts into a single uniform court language. Thus the invoker (USER) automatically provides instruction of his/her version of the content of the document in his her own language. The instruction means then converts the transcript of instructions provided by the person into a template to form the pleading.

[8] A search engine (SE): Once the template is uploaded into the Suit means in the form of an e-plaint then a search engine (SE) will scan the e-plaint and append the plaint with the relevant provisions from the enactments database (ED) and precedents from the precedents database (PD). The relevant enactments and precedents are appended to the e-plaint and form part of the pleadings record stored in the Case File (CF). In addition, the appointed lawyer (L) or the party (USER) can fetch and attach enactments or precedents as he desires but he/she cannot delete an enactment or precedent generated automatically. All these documents in digital form therefore constitute the filing precedent such as the e-plaint and finally stored at the Case File (CF). In case the plaintiff so desires he can request for a version of the e-plaint also stored in the language of his choice.

[9] Analyser Means (AM): there is provided an analyser means (AM) which invokes a search engine (SE) for a first time to scan relevant enactments and precedents which are appended to pleadings. Further, the analyser means includes means for examination of pleadings takes place. E-pleadings are initiated and examined for removal of objections on either side; plaintiffs and defendant's side, until a final set of acceptable pleadings are taken up for further processing. Still further, evidence in association with the entire proceedings will be analysed. The analyser means (AM) may be an analysing computer or an individual or a group of individuals. The e-analysis report generated by this means will form a part of the proceedings. The analyser means (AM) invokes the Search Engine (SE) for a second time to search for enactments and precedents now applicable to the case. This is done so that the time elapsed between the filing of the case and the trial of the case may have provoked additional enactments and precedents to be applicable to the case under consideration.

[10] Amendment Tool (AMT): According to yet another aspect of this invention, there is provided an amendment tool (AMT), which is adapted for enabling amendment to said plaint/written-statement after it has ‘freezed’. The amendment can be in the text of the pleadings or the appendages of the pleadings. This amendment can be effected by a lawyer (L) or USER or both. The amended document does not however replace the document produced by the pleading forming tool (PFT) which is machine generated. Thus the genesis of pleading-making is preserved, non-manipulated, and transparent to the tiers of the judicial panel for providing an unbiased judgement.

[11] Issue Framing Tool/Means (IFM): After all pleadings are complete the case will be handed over to the issue framing means (IFM) which will analyze the issues in the pleadings and frame e-issues. Admission/denial of documents and exhibits may be recorded in the e-proceedings.

[12] Interfacing Means (IM): there is provided an interfacing means (IM) to interface said e-plaint and said e-written-statement to a lawyer or a consortium of lawyers (L) for assisting either of the parties, i.e. the plaintiff and/or the defendant. This is done, typically as a premium service which attracts a fee from the respective petitioner/defendant (USER).

[13] Behaviour Analysis Unit (BAU): there is provided a behavioural analysis Unit (BAU), typically, to identify and record the credibility of the witnesses. The behavioural analysis Unit (BAU) comprises a human element and is also equipped typically with a lie-detection means, a heart rate monitoring means, a sweat-release monitoring means and the like psycho-physio change analysing means. Trained personnel are stationed to monitor, analyse and summarise the findings and reports of the equipment at said behavioural analysis unit (BAU). The statements recorded as a matter of fact at the BAU as well as the reports generated by said trained personnel at the BAU together form an e-confidential report which is available to the judicial panel (JP) before passing a judgement. According to another additional embodiment of this invention there is provided a setup typically of cameras, microphones, speakers, processors, interfacing means, storage means, and internet connection to carry out the cross-examination proceedings. Lawyers (L) on either side will pose questions remotely using the setup provided. Each question will have to be answered within a set period of time and will be recorded along with the objections of the counsel of the person being examined. These proceedings may be monitored by a judge from judicial panel (JP) in real-time over the internet.

[14] Judicial Centre (JC): Typically, it comprises a plurality of sections viz.: (i) Process Service Device (PSD): Once court fees are paid, and objections are removed by analyzer means (AM) in conjunction with the governance of the administrative panel (ADP), the summons are served through the process service device (PSD) to the defendant, typically by the bailiff or other serving means. Typically, this is done digitally via an id of the defendant, a lawyer of the defendant, or to a corresponding judicial centre used as a service point for said defendant. Also, a hard copy may be generated and dispatched. (ii) Recording Unit (RU): It is a set-up of cameras, microphones, speakers, processors, interfacing means, storage means, and internet connection between one remote judicial centre and another which facilitates the examination and cross-examination proceedings (evidence and arguments) at the Justice Centre (JC). Along with oral testimony, routinely other visual data may also be taken on record at the Recording Unit (RU). For instance in a land dispute, the land and site can also be filmed and included as evidence for a better appreciation of the case of the parties. Re-creation and simulated sequences can also be taken in as evidence for the same purpose. The recording unit (RU) connects to a behavioural analysis unit (BAU) which monitors and records various physiological signs of the witness to verify his authenticity and finally generates an e-confidential report (not accessible to the USER) for submission to the judicial panel (JP). (iii) Argument Section: this section facilitates the recording of evidence/argument which takes place at the judicial centre.

Parties (USER, L) can assemble at a judicial centre (JC-1, JC-2, JC-n) close to them respectively and record their evidence typically through a Recording Unit, (RU). This is done orally in the language of the witness and in the sight of a behaviour analysis unit (BAU) which will automatically record various signs of the witness. Cross examination is done by a lawyer (L) or an opposing litigant (USER). Alternatively, a witness may choose to record evidence at a convenient location after the witness has been appropriately wired up so that along with the testimony of the witness, his or her vital signs are also recorded including the demeanour, response time to a question, the blood pressure, temperature, neural conductivity, brain waves, pulse rate, breathing rate. All these signs are examined by the behaviour analysis unit (BAU) and along with the testimony, the e-confidential report of the BAU is also appended. This will remove all uncertainty relating to the veracity of the testimony and fear from the minds of an honest witness who may choose to lead evidence from the comfort of her home and without intimidation. Cross examination can also be done by the lawyer (L) or the opposing party remotely from another judicial centre (JC) and in real time. Each judicial centre (JC) is also equipped with a process service device (PSD) to relay the plaintiff's or court's notice to a defendant, typically to his e-mail id and his physical address/service of address and also to a judicial centre (JC) near and relating to said defendant.

In accordance with an additional embodiment of the pleading tool (PFT) is provided with a query generator means (QGT), typically adapted to generate a query in cases wherein, said recorded facts depict a lacuna, e.g. in cases wherein said facts do not follow sequentially or depict contradiction or do not adjust suitably to the drafting ability of said pleading tool (PFT). This query for eliciting a fact may be done manually or automatically by the pleading tool (PFT). The draft as done by the pleading tool (PFT) is first sent to the plaintiff (USER) or the defendant (USER) in a language of choice. It is even adapted to be sent in the form of an audio file (for catering to illiterate people). The plaintiff or defendant (USER) may further request changes from the pleading tool (PFT) for which, he introduces more facts or directs the changes manually as desired. After a set number of iterations between the pleading tool (PFT) and the litigant (USER), an enabling means freezes the pleading as final and renders it non-editable.

According to still another aspect of this invention, the pleading tool (PFT) is provided with an uploading means (UT) wherein, documents and exhibits may be scanned and introduced to substantiate the claims made by the plaintiff or defendant (USER).

During rendering of justice, said recorded text file or audio file can be served to the judge or panel of judges (JP) to be considered.

Once e-issues are framed, the system (100) transfers the case to the evidence recording section. In this section the parties (USER/L) are invited to lead evidence in support of their respective points of view.

After the pleadings and evidence stage, the case now moves on to the final arguments stage. In this stage the recording mechanism (RU) is again used for recording arguments. Arguments can be both in text and audio form and a video clip is made of the arguments. This may be either pre-prepared and submitted or can be recorded at a justice centre (JC) convenient to the litigants. The arguments can be presented by the litigants themselves (USER) or their lawyers (L). Arguments proceedings are not subjected to the behaviour analysis unit (BAU).

In accordance with an additional embodiment of this invention, a panel of available human judges (JP), typically 3 in number are selected at random from a repository of names stored in a judicial database. The entire proceedings of the case as output from the various means are presented before said panel.

In this way of randomisation, the propensity of the judge in relation to his outlook towards the case is obviated. The panel of judges, upon consideration of the arguments, counter-arguments, witness statements, evidences issues a decree in relation to the case. During this stage the panel of judges (JP) may call up any person or piece of evidence for questioning, which is again effected by tele-conferencing or video-conferencing at a justice centre. Appeals in relation to an order may further be relayed to an Appellate Panel (AP) and/or a Supreme Appellate Panel (SAP).

In accordance with yet another embodiment of this invention, there is provided a provision for obtaining interim injunctions. Said interim adjudication panel (IP) acts to enforce the provisions of passing a decree relating to interim orders and injunctions. Neither the judicial centre (JC) nor the other tiers of the judicial panel (JP) play a role in the administering of such cases. Only pleadings are served before said interim adjudication panel (IP). In cases, where ex-parte injunction is sought, no written statement is submitted. The matter is served to the interim adjudication panel (IP) consisting of only the plaint. This service may be provided, typically at a higher court fee. The decision, whether granted or rejected, may be decided upon additional evidence or arguments.

Appeals from the judgements dispensed by the judicial trial panel (JP), will basically use, the same system (100), with the added advantage that the appellate panel (AP) and the Supreme Appellate Panel (SAP) will have the benefit of scrutinising the complete records of the case, if they so desire.

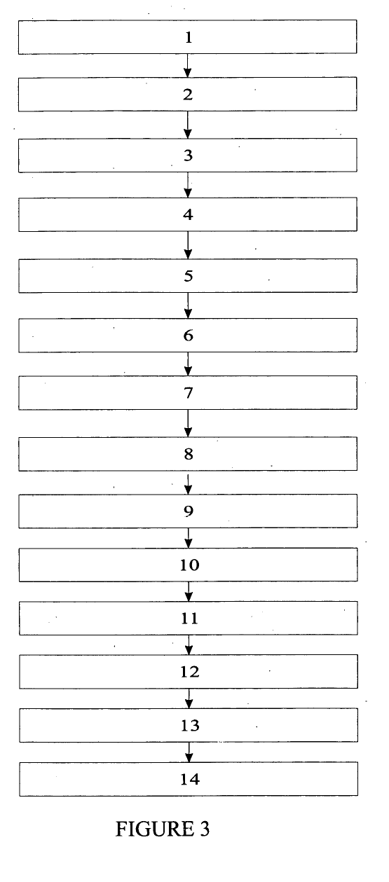

Several tiers of the judiciary are envisaged in the system (100) as elaborated in FIG. 3 of the accompanying drawings. There will be the administrative judiciary panel (ADP), such as the Registrars that will supervise the pleadings portion of a case. Then there will be trial judiciary panel (TP) that will supervise the evidence and the arguments stage. This will be followed by the judicial panel (JP) that will be involved in delivering the judgement from case to case. This separation of judicial functions will be by design rather than the random taking up of cases that is frequent in the present system, where a series of judges may be involved in a case or suit because of various reasons. The appellate panel (AP) will hear appeals. The final appeals will be heard by the apex appeal panel (AP) or supreme appellate panel (SAP) which is the equivalent of the Supreme Court. Additionally, there will be a panel of judges, typically the interim adjudication panel (IP) for providing interim orders and urgent orders. The case file (CF) as well as proceedings carried out at the judicial centre (JC) will be relayed to the respective judicial panel for issuing orders.

Judges will be elevated from tier to tier depending upon their seniority, experience and merit. Since all proceedings will be in a uniform Court language, Judges would be expected to be proficient in that language. There would be no question of transfer of Judges.

According to still another embodiment of this invention, there is provided an automatic time and date stamping means on each and every part of the proceedings. This includes all the documents in relation to the proceedings.

According to the aspects of this invention e-justice will to be administered expeditiously and inexpensively.

Several advantages can be outlined which highlight the applied advantages of the e-justice system in accordance with this invention. The advantages are discussed in the following:
1) The system in accordance with this invention will greatly help in reducing the backlog of case, and expedite the existing process of dispensing justice. Fast adjudication of justice will act as a stronger deterrent for impending violators of law.
2) The system in accordance with this invention will decrease the amount of storage and paperwork as everything will be digitally stored in disks, drives and the like media.
3) The need for large courtrooms will be obviated in accordance with this invention and consequently, large spaces in cities will be released for other purposes. In contrast, relatively smaller judicial centres will mushroom at strategic locations. The number of judicial centres will be in direct proportion to the quickening of the cases streamlined in the judicial system. Subsequently, travel time, wait time will be substantially decreased in because the lawyer, the judge, the witnesses, the plaintiff, the defendant will be required to travel only to a strategically, typically nearer, judicial centre.
4) The introduction of judicial centres located at pre-determined locations in accordance with this invention obviates the need for jurisdictional limitations which, currently each court services to. Each judicial centre is equipped to handle cases of any jurisdiction, thus providing a seamless national jurisdiction.
5) The transfer of judges which is a feature of the current judicial system will be stopped in accordance with this invention, as both lawyers as well as judges may remotely monitor and handle the proceedings of the case. Physical presence is obviated except at judicial centres, which in itself are interconnected via video-conferencing and telecommunication facilities to provide for an uninterrupted, seamless environment.
6) Serial flow of cases can largely be culminated in accordance with this invention, as the proliferation of judicial centres prompts simultaneous parallel attendance to the newer and newer cases.
7) The subjectivity issues of a judge with respect to a lawyer or the subject matter of the case is resolved in the system in accordance with this invention. Parallel processing of cases reduces the queue and competent judges in relation to the subject matter of the case can be found quickly. Also, since a tier of panels of judges supervise a case, the direct correlation between the influence of one single judge with respect to a lawyer or subject at hand reduces.
8) The present system is a victim of frequent adjournment of cases, partly due to genuine cause, partly due to flimsy causes, and partly due to fabricated causes. Typical example are sicknesses, lawyer's or parties' inability to show up at a hearing and the like forced or unforced measures. The date system can therefore be substantially arrested by the system in accordance with this invention, wherein, the documents may be filed at the party's leisure at the judicial centres without the need for occupying the courtroom-time.
9) In accordance with the system of the present invention, justice will be accessible to people without any bias towards their money-paying ability, as the system provides an option for a lawyer-free environment. The system is further tuned to absorb only the mental acumen of lawyers and make the influential ability of lawyers or parties at hand, obsolete.

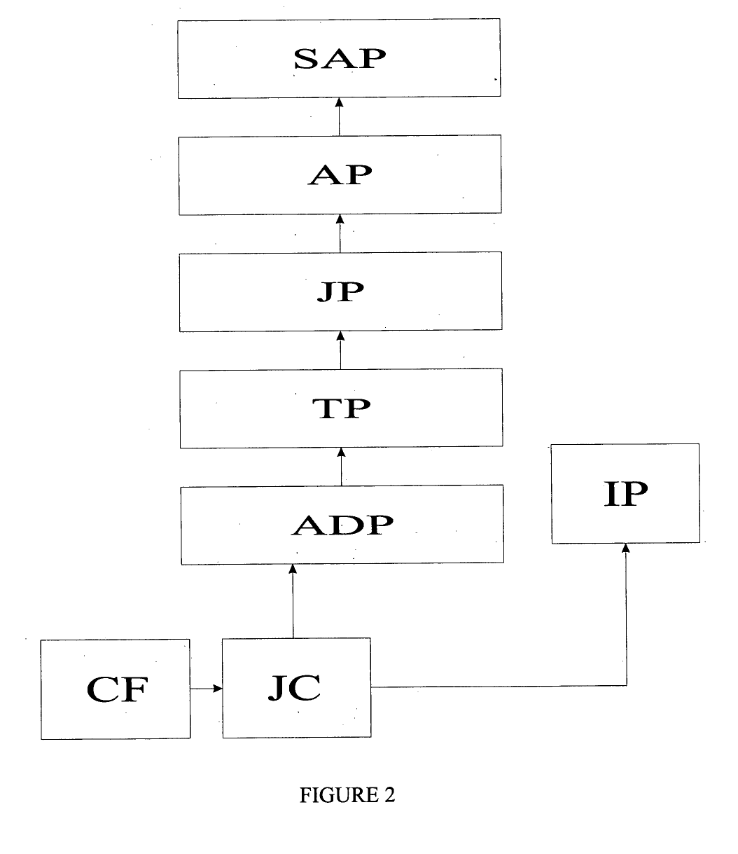

FIG. 2 illustrates the hierarchy and various tiers of the judicial system in accordance with the system of FIG. 1.

FIG. 3 illustrates a logical flow diagram of administering e-justice in accordance with this invention. Described below is a generic description of the entire proceedings right from initiating it to administering a judgement:

Step 1: A plaintiff (USER) invokes the system (100) through the suit/case generating means (S/C GM) by registering and providing the necessary details like providing his e-mail address, his physical address, and other details such as his bank details, or a lawyer (L) who may be pre-registered and pre-recognised by the system and whose service for address is provided. As soon as this is done, a case file (CF) which is typically initially blank is created. The case file (CF) is continually updated as the e-plaint is made, as the e-written statement is made, as the precedents searched by the search engine (SE) are added, as the enactments searched by the search engine (SE) are added, as the confidential reports from the behavioural analysis unit (BAU) are added, as e-reports from said analyser means (AM) along with additional appendages from search engine (SE) are added, as the amendments by lawyer (L) or USER are added, as the judgement and reports from, the justice centre (JC) and the judicial panel (ADP, TP, JP, IP, AP, SAP) are delivered and added.

Step 2: The plaintiff (USER) now accesses the pleading forming tool (PFT) to compile an electronic plaint. Firstly, he accesses the template generating means (TGT) which contains a storehouse of templates required in the pleadings. These templates are editable. The plaintiff (USER) uses the pleading instructions receiving tool (PIRT) to record a statement of facts (in audio format or text format) in a language convenient to the user. The Conversion Tool (CT) converts the template, into a core pleading. A Query Generator Means (QGT) generates queries leading to formation of a comprehensive and complete pleading. A search engine (SE) invoked for a first time by the analyser means (AM) searches the pleadings for key facts and then correlates the findings with the precedents of the Precedents' Database (PD) and the Enactments' Database (ED) to append the findings and form a final pleading. This final pleading as well as the statement of facts are uploaded to the case file (CF). The translation means (TM) converts said core pleading into an e-plaint in accordance with a particular fashion of making said plaint in the language of the Court. This obviates the problems resulting due to incompetence of a lawyer (or a person drafting the plaint) as all facts are on record and translated into the plaint without human intervention, thus disabling malpractice. The invoker (USER) is thus required to fill in all the details and facts in support of his or her case. Thus, there is an inbuilt translator. However, the original instructions provided by the proposed plaintiff or applicant are also appended to the created template for an, eventual, analysis whether the system has faithfully converted the transcript into the template and pleading. Thus the genesis of the pleading is preserved and rendered untaperable.

Step 3: Alternatively, the plaintiff (USER) can opt for the services of a lawyer (L) either provided by the system (100) or of his choice, who is equipped for converting the instructions into a template. The lawyer (L) accesses the Interfacing means (IM) to link with the system (100) in accordance with this invention. However, the original instructions will always be appended to the prepared template.

Step 4: The lawyer (L) or the plaintiff (USER) may use the amendment tool (AMT) to change the text of the pleading or attach precedents, enactments to the formal pleading. The already appended pleadings searched by the search engine (SE) cannot be deleted. The amended document does not however replace the document produced by the pleading forming tool (PFT) which is machine generated. Thus the genesis of pleading-making is preserved, non-manipulated, and transparent to the tiers of the judicial panel for providing an unbiased judgement.

Step 5: The plaintiff (USER) uses the services of the Court Fee Tool (CFT) to pay the government charges relating to the court fee as well as the processing fee.

Step 6: Once pleadings are formed and fees are paid, the plaintiff utilises the services of a nearby Judicial Centre (JC1). A judicial centre is equipped, with administrative judges who look after administrative matters, typically to remove objections. It further includes a process service device (PSD) wherein, the system serves summons or notice to the defendant via a digital copy, a hard copy and/or lawyer (L) of the defendant. If an email ID of the defendant is available, the service is affected over the internet using a registered receipt facility. In case an email of the defendant is not available, the e-plaint is transmitted electronically to the nearest judicial centre (JC) for physical service along with a digital copy of the e-plaint. On receipt of the e-plaint, the defendant is required to provide a written statement which is again generated using the pleading generating tool (PFT). Again here the services of a lawyer (L) may be used but the instruction of the defendant will be appended compulsorily, with the written statement. Normally no other pleadings will be permitted and the e-pleading stage is thus completed. Additional pleadings by either side will be allowed only in rare cases on the payment of additional fees.

Step 7: The defendant further utilises the services of the system (100) to form his written statement or a lawyer (L) who through the system (100) prepares a written statement in a similar manner as the plaintiff (USER) has formed the plaint. The written statement as well as the defendant need not be present at the plaintiff's judicial centre (JC-1) but can access the facilities of a remote judicial centre (JC-2) which is sufficiently networked to the plaintiff's judicial centre (JC-1).

Step 8: E-pleadings are initiated. These e-pleadings are examined by the administrative panel (ADP) for removal of objections on either side until a final set of acceptable pleadings can be taken up for further processing. This is done by the analyzer means (AM).

Step 9: Exhibits and documents purporting to be evidence in relation to the e-case are scanned and introduced in the proceedings by a trial panel (TP). The admission/denial of evidence is recorded. An e-affidavit to the effect that the evidence submitted is true and valid is filed by either party. This is done by the Issue Framing Means (IFM).

Step 10: An analyser (AM) analyses the entire set of documents and in conjunction with an issue-framing means (IFM) draws a set of issues for attracting arguments and counter-arguments from the prosecutor and defence counsels.

Step 11: A set-up of cameras, microphones, speakers, processors, interfacing means, storage means, and internet connection facilitates the examination and cross-examination proceedings (evidence and arguments) at the Recording Unit (RU) located at the Justice Centre (JC). The recording unit (RU) connects to a behavioural analysis unit (BAU) which monitors and records various physiological signs of the witness to verify his authenticity. Lawyers (L) on either side pose questions remotely using the setup provided. Each question has to be answered within a set period of time and is recorded along with the objections of the counsel of the person being examined. These proceedings are monitored by a judge in real-time over the internet. These recordings form a part of the case file (CF) too.

Step 12: An analyser means (AM) analyses the evidence in association with the entire proceedings. It forms an e-analysis report which forms a part of the proceedings. The analyser means (AM) further invokes the Search Engine (SE) for a second time to search for enactments and precedents now applicable to the case. This is done so that the time elapsed between the filing of the case and the trial of the case may have provoked additional enactments and precedents to be applicable to the case under consideration.

Step 13: A judge or a panel of judges (JP) is selected from a repository of judges to preside over a case and to deliver judgement. The entire activity of the e-justice setup including the e-documents, citations (e-judgements, e-case studies, e-commentaries, provisions of law), evidence, e-analysis report is relayed to the human judge. The judge draws his conclusion in light of all the evidence and provisions of the law and administers an e-judgement.

Step 14: The administered e-justice is uploaded to the case file (CF) and stored in a database (PD) of previous judgements for future reference.

While considerable emphasis has been placed herein on the components and component parts of the preferred embodiments, it will be appreciated that many embodiments can be made and that many changes can be made in the preferred embodiments without departing from the principles of the invention. These and other changes in the preferred embodiment as well as other embodiments of the invention will be apparent to those skilled in the art from the disclosure herein, whereby it is to be distinctly understood that the foregoing descriptive matter is to be interpreted merely as illustrative of the invention and not as a limitation.

1) An electronic judicial system adapted to carry out proceedings of a court, said electronic justice system comprising:
an enactments' database adapted to store electronic versions of a plurality of enactments;
a precedents' database adapted to store a plurality of precedents;
a suit/case generating means adapted for use by a potential litigant to invoke said electronic judicial system and further adapted to permit logging into said system with all the facts relating to said suit/case;
a pleading forming tool comprising:
a) a template generating tool comprising a plurality of templates and adapted to generate electronic versions of pleadings;
b) pleading instructions receiving tool adapted to prompt statement of facts from an invoker of said system in language of said invoker to generate said electronic versions of pleadings;
c) conversion tool adapted to convert said pleadings' instructions to a core pleading;
d) query generator means adapted to generate queries in cases wherein, said recorded facts depict a lacuna in formation of said electronic version of pleadings; and
e) translation means adapted to convert said prompted statement of facts and said generated electronic versions of pleadings in a uniform court language;
search engine adapted to scan said generated versions of pleadings and append to it, relevant provisions from said enactment database and said precedents' database to make a final formal pleading;
court fee tool adapted to service payment transactions relating to payment of court fees;
uploading tool adapted to upload documents and exhibits in scanned manner in order to substantiate claims of said plaintiff and said defendant;
analyzer means adapted to examine pleadings, remove objections, and formulate a final set of acceptable pleadings;
issue framing means adapted to analyze issues in the pleadings, frame electronic version of issues, record admission or denial or said exhibits and documents;
behavioural analysis unit adapted to monitor and analyse witness physical signs while recording evidence;
interfacing means adapted to interface said electronic version of plaint and said electronic version of written statement with a lawyer or a consortium of lawyers;
case file means adapted to receive and store pleadings generated by said pleading forming tool, reports from said behavioural analysis unit, e-reports from said evidence analyser unit, amendments to said pleadings by said lawyer or said user, and rendered justice order;
amendment tool adapted to amend said electronic version of plaint and written statement;
judicial centre adapted for handling administrative matters relating to litigation and recording of evidence comprising:
i) process service device adapted to serve summons to said defendant; and
ii) recording unit adapted to record evidence, arguments and communicate with said behavioural analysis unit and further adapted to store said recorded evidence and said recorded arguments in said case file; and
judicial panel adapted to receive and study said case file and issue a judgement.

2) A system as claimed in claim 1 wherein, said enactments' database is update-able.

3) A system as claimed in claim 1 wherein, said enactments' database includes a section for storing enactments relating to other countries and jurisdictions.

4) A system as claimed in claim 1 wherein, said precedents' database is update-able.

5) A system as claimed in claim 1 wherein, said suit/case generating means includes a case identification generating means adapted to identify a user with said relevant case.

6) A system as claimed in claim 1 wherein, said template generating tool includes templates selected from a plurality of templates including plaints' templates, written statements' templates, rejoinders' templates, surrejoinders' templates, and sursurrejoinders' templates.

7) A system as claimed in claim 1 wherein, said pleading instruction receiving tool includes a language translation and language recognition tool.

8) A system as claimed in claim 1 wherein, said pleading instruction tool is adapted to receive instructions in a text format.

9) A system as claimed in claim 1 wherein, said pleading instruction tool is adapted to receive instructions in an audio format.

10) A system as claimed in claim 1 wherein, said conversion tool includes a set of pre-defined instructions to convert said pleadings' instructions to a core pleading.

11) A system as claimed in claim 1 wherein, said translation means includes a language conversion tool adapted to cater to a plurality of languages.

12) A system as claimed in claim 1 wherein, said analyser means is adapted to collate evidence in relation to entire case proceedings to generate an e-report and invoke said search engine to scan enactments and precedents and append to said e-report.

13) A system as claimed in claim 1 wherein, said system includes a security means adapted to provide security to said case file, and operable only by said user and said lawyer.

14) A system as claimed in claim 1 wherein, said system includes a relaying means adapted for communication, transmittal and receipt of documents between said plaintiff, said defendant, said lawyer of said plaintiff, said lawyer of said defendant, and said judicial centre.
